(19) United States
(12) Patent Application Publication
(10) Pub. No.: US 2011/0102185 A1
(43) Pub. Date: May 5, 2011

(54) POWER-DRIVEN WINDOW SHADE WITH AN ALARM DEVICE

(76) Inventor: Wei-Cheng Yeh, Gangshan Township (TW)

(21) Appl. No.: 12/633,732

(22) Filed: Dec. 8, 2009

(30) Foreign Application Priority Data
Oct. 30, 2009 (TW) 098220167

(51) Int. Cl. G08B 21/00

(52) U.S. Cl. 340/636.16

(57) ABSTRACT

A power-driven window shade mainly utilizes a controlling device connected to an alarm which includes a power storage respectively connected to a power device and a processing unit of the controlling device, and a detector connected to the power device. If a sudden interruption of electricity supply occurs while the window shade is still running, the detector would generate a warning signal reaction to any abnormal electrical variation and transmit it to the processing unit. Whereby, the processing unit helps a counter save its counting value via the electricity pre-stored in the power storage, and by following the previous saved counting value, the counter is able to continue its counting after resuming the electricity supply. Thus, the present invention preferably prevents from the conventional potential rolling error as well as inconvenient resetting due to an unexpected shutdown of electricity supply.

### BACKGROUND OF THE INVENTION

1. Field of the Invention

The present invention relates to a design of electronic blind, particular to a power-driven window shade with an alarm device that obviates a possibility of counting failure while electricity is cut off.

2. Description of the Related Art

Referring to FIGS. 1 and 2, a conventional window shade 1 comprises a rail 11, a rolling shaft 12 pivoted on the rail 11, a covering sheet 13 rotated by the rolling shaft 12, a power 14 for driving a rotation of the rolling shaft 12, a controlling device 15 for controlling the power 14, and a power device 16 for providing the controlling device 15 and the power 14 with electricity. Wherein, the controlling device 15 includes a sensor 151 for sensing a rolling distance of the rolling shaft 12 and producing a signal, a counter 152 for counting the sensed signal from the sensor 151 into a measured value, a processing unit 153 capable of controlling the power 14 connected to the counter 152, and a memory unit 154 connected to the processing unit 153.

Still referring to FIG. 2, while in manipulation of the window shade 1, users need to set an uppermost and a lowest limit position of the covering sheet 13. Namely, when the covering sheet 13 initially descends to the lowest limit position, the sensor 151 could concurrently sense the rotation of the rolling shaft 12. Whereby, the revolution thereof would be thence counted and converted into a data by the counter 152, so that the memory unit 154 would save the data via the processing unit 153. Accordingly, the covering sheet 13 would be succeedingly raised and descended depending on the actual amount counted by the counter 152. Hence, when the counting number equals to the data saved in the memory unit 154, the processing unit 153 prevents the power 14 from running.

However, if an electricity outage happens or unsuitable outer force acts on the power-driven window shade 1 unpredictably while the power-driven window shade 1 is still running, the counter 152 would be forced to interrupt the counting. Wherein, the value that is counted before shutting off would not be saved. Namely, while resuming the electricity supply, the counter 152 has no counting basis for continuing former counted value. In such situation, the counter 152 usually confuses the revolution number of furling the covering sheet 13 with the revolution number of lowering the covering sheet 13. As a result, if the counter 152 resumes the counting anyway, an inaccurate counting would cause the covering sheet 13 to stop at an imprecise position. Therefore, a re-adjustment is needed after the unpredictable shutting off, which incurs an inconvenient using and requires a proper amending to the disadvantages.

### SUMMARY OF THE INVENTION

Therefore, the object of the present invention is to provide a power-driven window shade for efficiently pre-saving a counting value before unpredictable shutting off happens; whereby, the continuation of rolling the window shade could be succeedingly proceeded after the electricity is resumed, and a repeated setting is prevented.

The power-driven window shade in accordance with the present invention mainly provides with a rail, a rolling shaft pivoted on the rail, a covering sheet rolled by the rolling shaft, a power for driving the rolling shaft, a controlling device for controlling the power, and a power device for respectively providing the controlling device and the power with electricity. Wherein, the controlling device connects to an alarm, which further has a power storage respectively connected to the power device and the processing unit, and a detector installed on the power device. Thereby, if the window shade suddenly stops running due to an accidental electricity outage or shutting off, the detector would detect an electrical variation indicative of the upcoming shutdown beforehand. Namely, upon any abnormal electricity state is detected, a warning signal would be sent to the processing unit. Whereby, the processing unit would provide the electricity that is pre-stored in the power storage to a counter of the controlling device for saving the counting value presenting the former revolution of the covering sheet. Hence, the counter could continue the counting in accordance with the counting value saved previously after the electricity supply is resumed. That is to say, the present invention utilizes the counting value saved before the electricity outage to exclude an interrupted counting value that facilely leads to a fault in the subsequent rolling. Moreover, a repeated setting is also avoided.

The advantages of the present invention would be apparent in following embodiments with drawings, and like elements are denoted by same numerals throughout the disclosure.

### BRIEF DESCRIPTION OF THE DRAWINGS

FIG. 1 is a perspective view showing a conventional invention;

FIG. 2 is a block diagram showing the conventional invention;

FIG. 3 is a perspective view showing a first preferred embodiment of the present invention;

FIG. 4 is a block diagram showing the first embodiment; and

FIG. 5 is a block diagram showing a second embodiment.

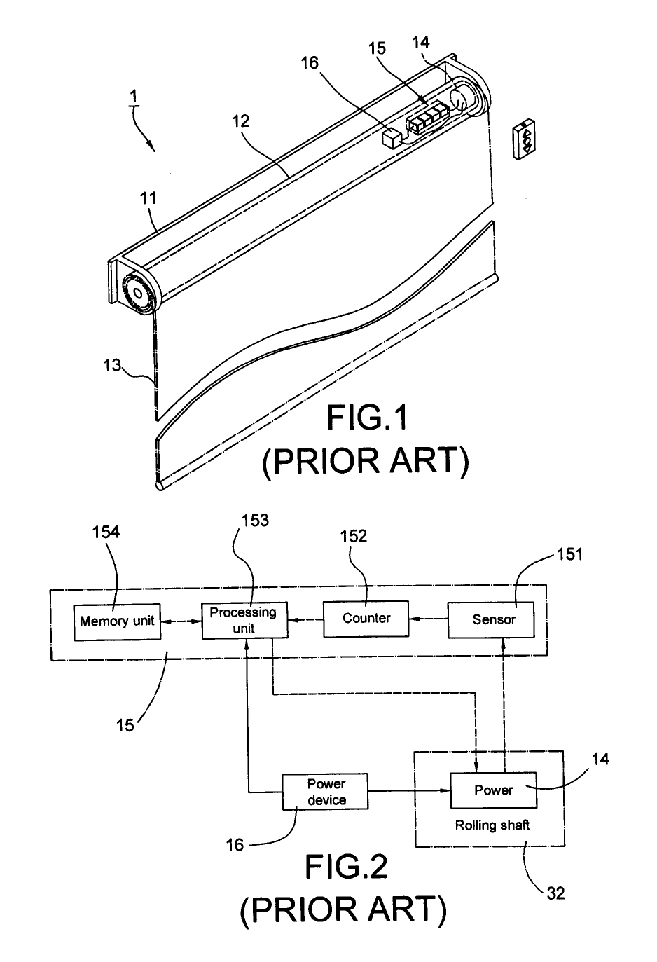

### DETAILED DESCRIPTION OF THE PREFERRED EMBODIMENTS

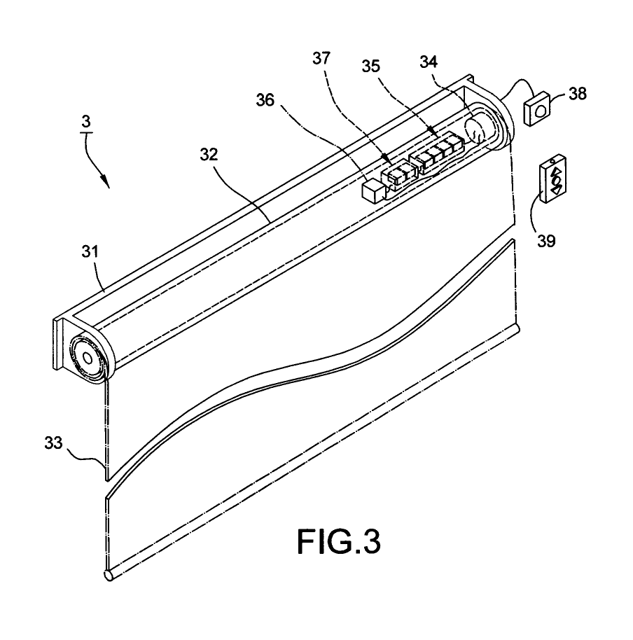

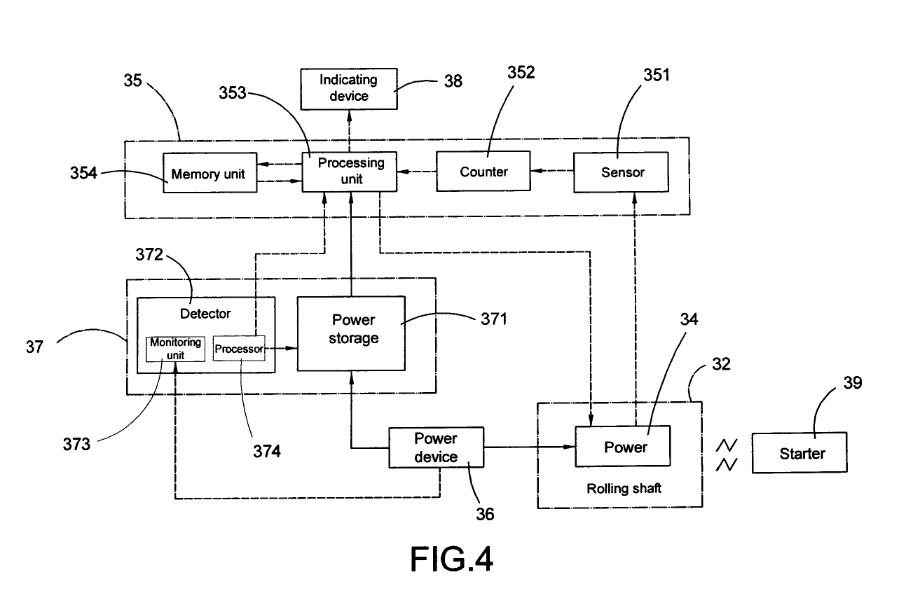

FIGS. 3 and 4 show a first preferred embodiment of a power-driven window shade 3. The window shade 3 comprises a rail 31, a rolling shaft 32 pivoted on the rail 31, a covering sheet 33 motivated by the rolling shaft 32, a power 34 for rotating the rolling shaft 32, a controlling device 35 for controlling the power 34, a power device 36 for respectively providing the controlling device 35 and the power 34 with electricity, and an alarm 37 connected to the controlling device 35. Wherein, the controlling device 35 includes a sensor 351 for sensing a rolling distance of the rolling shaft 32 and producing a sensed signal, a counter 352 for counting the sensed signal from the sensor 351 into a measured value, a processing unit 353 connected to the counter 352 for controlling the power 34, and a memory unit 354 connected to the processing unit 353. In this embodiment, the processing unit 353 further connects to an indicating device 38, which acts on giving a message like sounding or lighting for obviously performing the using state of the window shade 3.

Succeedingly, the alarm 37 includes a power storage 371 respectively connected to the power device 36 and the processing unit 351 and a detector 372 installed on the power device 36. Wherein, when the power storage 371 saves part of the electricity outputted by the power device 36 therein, the rest of the electricity would be also provided to the processing unit 353. As it should be, the power storage 371 could adopt a capacitor or other electronic parts that could save electricity. Herein this embodiment, the power storage 371 adopts the capacitor. As to the detector 372, it has a monitoring unit 373 connected to the power device 36, and a processor 374 connected to the monitoring unit 373 and the processing unit 351. Moreover, a power value is previously saved in the processor 374 for serving as a basis which could be accordingly compared and distinguished with the electricity outputted from the power device 36. Furthermore, the power 34 in this embodiment could further connect to a starter 39 by either a wireless remote control or a wired button switch type. Thereby, the starter 39 could immediately trigger the power 34. In this embodiment, the starter 39 adopts the wireless remote control.

Referring to FIGS. 3 and 4, in operation, users need to set a proper uppermost limit position and a lowest limit position of the covering sheet 33 before using the window shade 3. Wherein, the uppermost and lowest limit positions would be saved in the memory unit 354. Afterwards, users press buttons on the starter 39 to trigger the power 34, so that the rolling shaft 32 would be concurrently motivated to roll the covering sheet 33. In time of the rolling, the counter 352 would count the rolling distance of the rolling shaft 32 as a measured numeral, and when the counted numeral equals to the value pre-saved in the memory unit 354, the processing unit 353 would ask the power 34 to stop operation. Herein, during the charging of the power device 36, the power storage 371 would pre-store part of the electricity provided from the power device 36 and then deliver rest of the electricity to the controlling device 35. At the same time, the monitoring unit 373 of the detector 372 monitors the status of outputting electricity from the power device 36 without interruption. Accordingly, if the rolling shaft 32 suddenly stops rotating due to the accidental electricity outrage or shutting off, the voltage and current showing the electrical status from the power device 36 would be gradually decreased. Concomitantly, when the monitoring unit 373 finds the actual electrical state lower than the power value saved in the processor 374, the processor 374 would emit a warning signal to the processing unit 351, so that the processing unit 351 would immediately employ the saved electricity in the power storage 371 for the counter 352 to save the counting value in advance. Whereby, the counter 352 could proceed with its previously saved counting after the electricity supply is resumed. Namely, the counting value of the counter 352 would not be interrupted, and the revolution of the window shave 3 would not be subject to erroneous. Preferably, the resetting is omitted after the resumption, which favorably promotes the using convenience.

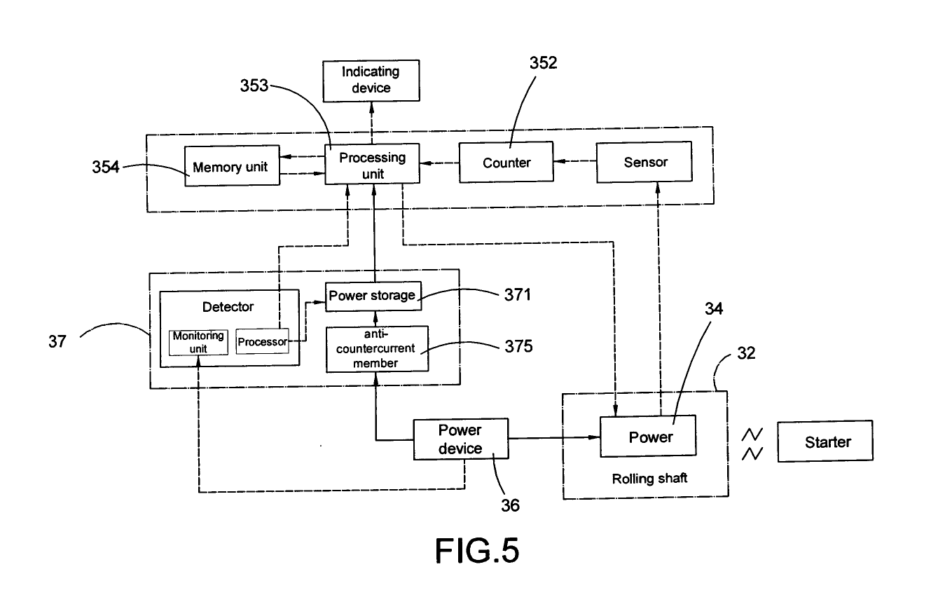

FIG. 5 shows a second preferred embodiment of the present invention. The power-driven window shade 3 comprises the equivalent elements as well as comparable effects as those of the first embodiment shown in FIG. 3, like the rail 31, the rolling shaft 32, the covering sheet, 33, the power 34, the controlling device 35, the power device 36, and the alarm 37. The similar constituents and efficiency are herein omitted. In this embodiment, an anti-countercurrent member 375 is disposed between the power storage 371 of the alarm 37 and the power device 36. As it should be, the anti-countercurrent member 375 could adopt either a diode or other electronic parts that could prevent from the countercurrent. In this embodiment, the anti-countercurrent member 375 adopts the diode. Whereby, the anti-countercurrent member 375 preferably impedes the reflux of the electricity to avoid the running-off. As a result, the saved electricity in the power storage 371 could be assured to timely provide the processing unit 353 with sufficient electricity. Thus, the counting value of the counter 352 could be well saved.

To sum up, the present invention takes advantage of a power storage and a detector installed on the controlling device. By means of the detection from the detector and the electrical assistance of the power storage, a timely storage of the counting value could be well saved from the counter via the processing unit if the rolling of the window shade is accidentally stopped because of an unpredictable electricity outrage. Consequently, when the electricity is resumed, the counter could proceed its counting by following the former saved counted value. Therefore, an interruption of the counting value could be avoided to efficiently eliminate the possibility of rolling error resulting by the unexpected electricity outrage. Moreover, the power-driven window shade of the present invention does not need a resetting anymore when retrieving the electricity supply after the interruption or the shutdown.

Various modifications may be made in further embodiments described without departing from the spirit and scope of the invention.

I claim:

1. A power-driven window shade with an alarm device comprising a rail, a rolling shaft pivoted on said rail, a covering sheet revolved and rolled by said rolling shaft, a power for rotating said rolling shaft, a controlling device for controlling said power, and a power device for providing said controlling device and said power with electricity, respectively; wherein, said power device offering said electricity with a certain voltage and current; said controlling device including a sensor for sensing a rolling distance of said rolling shaft and generating a sensed signal, a counter for counting said sensed signal generated from said sensor into a measured value, a processing unit capable of controlling said power connected to said counter, and a memory unit connected to said processing unit;
wherein, said controlling device connecting with an alarm that includes a power storage respectively connected to said power and said processing unit and a detector connected to said power device; said power storage being installed between said power device and said processing unit for providing said processing unit with electricity; said detector having a monitoring unit connected to said power device and a processor connected to said monitoring unit and said processing unit; a power value being saved in said processor for serving as a threshold so as to compare said electricity output from said power device with said power value for a distinguishing.

2. The power-driven window shade as claimed in claim 1, wherein, said power storage adopts a capacitor.

3. The power-driven window shade as claimed in claim 1, wherein, an anti-countercurrent member is disposed between said power storage and said power device.

4. The power-driven window shade as claimed in claim 1, wherein, said processing unit further connects to an indicating device.
